(19) United States
(12) Patent Application Publication
(10) Pub. No.: US 2013/0181907 A1
(43) Pub. Date: Jul. 18, 2013

(54) FLEXIBLE ELECTRONIC FLOOR MAT WITH KEY SWITCHES, OPTIONAL POINTING DEVICE AND OVERLAYS SELECTED BY JUMPING OR HOPPING

(71) Applicants: Marge Russell, Raleigh, NC (US); Philip J. Quinn, Raleigh, NC (US)

(72) Inventors: Marge Russell, Raleigh, NC (US); Philip J. Quinn, Raleigh, NC (US)

(21) Appl. No.: 13/741,276

(22) Filed: Jan. 14, 2013

Related U.S. Application Data
(60) Provisional application No. 61/586,611, filed on Jan. 13, 2012.

(51) Int. Cl. G06F 3/02

(52) U.S. Cl. CPC G06F 3/0219
USPC 345/172

(57) ABSTRACT

A flexible, reflective electronic floor mat has keys, play zones, an optional pointing device and optional overlays for games, texting, browsing, internet and social media, with switches selected by physical movement, such as jumping or hopping. The mat can be from about 3 feet to about 6 feet wide and from about 6 feet to about 12 feet long, typically under 7/16 inch in thickness, allowing rolling and carrying, with an attached controller and one or two handheld controllers with optional loopback sensing for games. The mat is compatible with internet television boxes, desktops, laptops, tablets and game consoles, along with wireless protocols and wired systems. The mat can be used to text, email, browse, play games or engage in social media with one's feet by jumping and hopping, providing tremendous physical benefit. This is an aerobic alternative to texting, browsing, email, social media and gaming for children and adults.

### CROSS-REFERENCE TO RELATED APPLICATION

This application claims the benefit of priority of U.S. provisional application No. 61/586,611, filed Jan. 13, 2012, the contents of which are herein incorporated by reference.

### BACKGROUND OF THE INVENTION

The present invention relates to computer devices and, more particularly, to computer peripherals that supply various signals to software applications and games via a processor. More specifically, the present device is a very large foot operated proprietary keyboard and game button interface for use with most computer or internet-configured devices. However, the foot operation cannot be performed from a seated or bench position; operation must be while standing, hopping or jumping, providing great aerobic benefit.

Both children and adults suffer from severe inactivity resulting in obesity, partly due to the many hours spent on small electronic devices for gaming and texting requiring the use of only one's fingers or hands with long hours seated. The current structure of education aggravates the sedentary lifestyle. In addition, few options are available to the digitally disabled (disability of the hands or fingers) for communicating or gaming via computer or internet. Moreover, there does not exist a fitness-oriented way for an adult to communicate, check email, browse or text without also spending long hours at a chair, couch or desk with a laptop or a tiny phone device causing eye and wrist strain.

There are floor mat devices that communicate electronically with game consoles or computers, however, these conventional mat devices currently in the marketplace or in other existing patents appear to concentrate on one specific type of play or type of education or communication. Therefore, these devices serve a narrow market and a specific purpose or niche; none appear to provide an aerobic experience for any and all functions for which a computer might be used. For example, there appear to be several styles of hopscotch mats, and several styles of childhood teaching mats, and a dedicated dance mat, but there appear to be no devices that incorporate browsing and Internet TV functionality, communication, education, fitness and entertainment (computer games) all in one sleek device.

Current patents include electronic hopscotch mats disclosed in U.S. Pat. No. D638,069, U.S. Pat. No. D6,251,032, U.S. Pat. No. 5,803,835, and U.S. Pat. No. 4,720,789, electronic childhood education teaching mats disclosed in US20100297597A1, U.S. Pat. No. 7,465,263, U.S. Pat. No. 5,836,835, and U.S. Pat. No. 5,997,304, an electronic typewriter style mat disclosed in US20090015440A1, a phone style keypad texting mat disclosed in US20090221372A1, one or two versions of an electronic switch mat for games only disclosed in US20090258704A1, and U.S. Pat. No. 4,720,789 and electronic dance mats disclosed in U.S. Pat. No. 7,854,686.

As can be seen, there is a need for a flexible electronic floor mat with key switches, optional pointing device and overlays for games, texting, browsing, email, internet television and social media, where selections are made by physical movements, such as jumping or hopping.

### SUMMARY OF THE INVENTION

In one aspect of the present invention, a flexible floor mat comprises a keyboard graphic top panel defining a plurality of keys; a plurality of switches disposed under the plurality of keys, wherein pressure applied to one of the plurality of keys closes one of the plurality of switches; and a bottom side resistant to slipping on a floor surface, wherein at least one of the plurality of keys is dedicated to social media interaction; at least one of the plurality of keys is dedicated to an internet browser; and at least one of the plurality of keys is dedicated to a texting application.

In another aspect of the present invention, a flexible floor mat comprises a keyboard graphic top panel defining a plurality of keys; a plurality of switches disposed under the plurality of keys, wherein pressure applied to one of the plurality of keys closes one of the plurality of switches; a bottom side resistant to slipping on a floor surface; and a hand-held controller having a trackball that is interactive with the flexible floor mat, wherein at least one of the plurality of keys is dedicated to social media interaction; at least one of the plurality of keys is dedicated to an internet browser; at least one of the plurality of keys is dedicated to a texting application; a subset of the plurality of keys mimics a 10-key calculator; and at least one of the plurality of keys is a safe zone where stepping on the safe zone does not trigger one of the plurality of switches.

These and other features, aspects and advantages of the present invention will become better understood with reference to the following drawings, description and claims.

### BRIEF DESCRIPTION OF THE DRAWINGS

FIG. 1 is a top view of a flexible electronic floor mat according to an exemplary embodiment of the present invention;

FIG. 2 is a top view of an alternate configuration of a flexible electronic floor mat according to an exemplary embodiment of the present invention;

FIG. 3 is a top view of an optional overlay for the flexible electronic floor mat of FIG. 1 or 2, providing an alternate key layout;

FIG. 4 is a bottom view of a top layer of silver conductive ink used in forming an exemplary switch under the top layer of the floor mat of the present invention;

FIG. 5 is a top view of a bottom layer of silver conductive ink used in forming an exemplary switch under the top layer of the floor mat of the present invention;

FIG. 6 is a top view of a carbon layer disposed on each side of the top layer and bottom layer of silver conductive ink, as shown in FIGS. 4 and 5, in an exemplary embodiment of the switch; and

FIG. 7 is a top view of a foam layer disposed between the top layer and bottom layer of silver conductive ink, as shown in FIGS. 4 and 5, in an exemplary embodiment of the switch.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a flexible, reflective electronic floor mat with keys, play zones, an optional pointing device and optional overlays for games, texting, browsing, internet and social media, with switches selected by physical movement, such as jumping or hopping. The mat can be from about 3 feet to about 6 feet wide and from about 6 feet to about 12 feet long, typically under 7/16 inch in thickness, allowing rolling and carrying, with an attached controller and one or two handheld controllers with optional loopback sensing for games. The mat is compatible with internet television boxes, desktops, laptops, tablets and game consoles, along with two types of wireless protocols, and wired systems. The normal use of the mat would be to text, email, browse, play games or engage in social media with one's feet by jumping and hopping, providing tremendous physical benefit. This is an aerobic alternative to texting, browsing, email, social media and gaming for both children and adults.

The device can be designed as a soft, padded, rollable, keyboard floor mat that will be compatible with internet television devices, desktops, laptops, tablets and game consoles—the signals are sent to the processor located either in the TV itself, or the TV's internet television box, or else located at the computer processor, tablet processor or game console with the selections viewable on a TV screen, computer monitor or tablet device.

As stated above, both children and adults suffer from severe inactivity resulting in obesity partly due to the many hours spent on small electronic devices for gaming and texting requiring the use of only one's fingers or hands and long hours seated. The current structure of education aggravates the sedentary lifestyle. In addition, few options are available to the digitally disabled (disability of the hands or fingers) for communicating or gaming via computer or internet. Moreover, there does not exist a fitness-oriented way for an adult to communicate, check email, browse or text without also spending long hours at a chair, couch or desk with a laptop or a tiny phone device causing eye and wrist strain.

There are floor mat devices that communicate electronically with game consoles or computers, however, the mat devices currently in the marketplace or in other existing patents appear to concentrate on one specific type of play or type of education or communication. Therefore, these devices serve a narrow market and a specific purpose or niche; none appear to provide an aerobic experience for any and all functions for which a computer might be used. For example, there appear to be several styles of hopscotch mats, and several styles of childhood teaching mats, and a dedicated dance mat, but there appear to be no devices that incorporate internet browsing, internet television functionality, social media, communication, education, fitness and entertainment (computer games) all in one sleek device. The invention claimed here solves this problem.

The device is a soft, padded, rollable, keyboard floor mat that will be approximately 3′ by 6′ or 4′ by 8′ for the adult size, and 6′ by 12′ for serious gamers. Of course, other sizes are contemplated within the scope of the present invention. The device is lightweight and with a controller that stores inside a foam lined case. The device provides connectivity with internet television, desktops, laptops, tablets and game consoles—the signals are sent to the processor located either in the TV itself, or the TV's internet television box, or computer processor, tablet processor or game console with the selections viewable on the TV or monitor.

Either one or two mats simultaneously may be used for competition games where teams race each other to spell words by hopping or jumping, or, the two mats may be used side by side for more elaborate gaming where the two mats could complete a 12 by 12 grid and overlaid graphics identify new moves that would be enabled by software. The embodiment of the device as a single mat without an optional overlay may be used regularly as the primary peripheral for aerobic texting, browsing, social media and gaming for children and aerobic business communication for adults.

The mat can be, for example, available in two or three sizes. The first two sizes planned are the child size and the teen-adult size. The first is approximately 73″ by 40″ and the second is 96″ by 50″. The letters can be laminated or embossed for tactile response when the user is barefoot or wearing socks. The characters can be printed in luminescent inks or reflective vinyl allowing for nighttime use in dark rooms or covered porch.

The mat is portable and water resistant and can be wiped down with soap and water. The interior layers can be made of stamped circuit switches involving carbon paper and printed conductive ink and rest atop a bottom layer of thin vinyl-like, plastic, polymer, rubber or thermoplastic elastomer material with a nonskid bottom surface for use on a smooth hardwood or ceramic floor. Other pressure sensitive switch configurations may be used within the scope of the present invention. The mat may also be used on carpet.

The normal use of the mat would be to text, email, internet browse, check social media sites or play games with one's feet providing a dance-like aerobic experience without requiring the skill, form or agility associated with current dance games on the market, but providing a welcome break from the normal eye strain and wrist strain involved in long hours at a traditional keyboard.

The device requires that the user trigger the switches via feet or hands and feet and the surface area is large enough to guarantee considerable aerobic activity, stretching and reaching by hopping and jumping onto the characters and game zones. In the case of overlays, there will be specific software that would change the response of a specific key. For instance, an overlay of a Treasure Hunt through the woods would have companion software that could program the B and N keys in such a way that stepping on them alternately would cause the screen character to walk through the woods, and the Y key could be used for jumping over a stream, forcing the player to literally jump onto the Y. The printed graphic overlay in this option would be affixed by Velcro™ to the initial mat. The areas over B and N could show a pair of footprints and the area over the Y would simply say “JUMP.” The entire mat would be programmed for the various moves needed through the woods and the movements and actions would be mimicked by the character on the screen. This will enable the device of the present invention to be used by developers for a host of computer and internet games. Any technological obstacles to development of this phase of the device should not be construed as voiding the patent since the technology of the single mat experience with an alpha key layout and internet, social media and games zones is unique in itself.

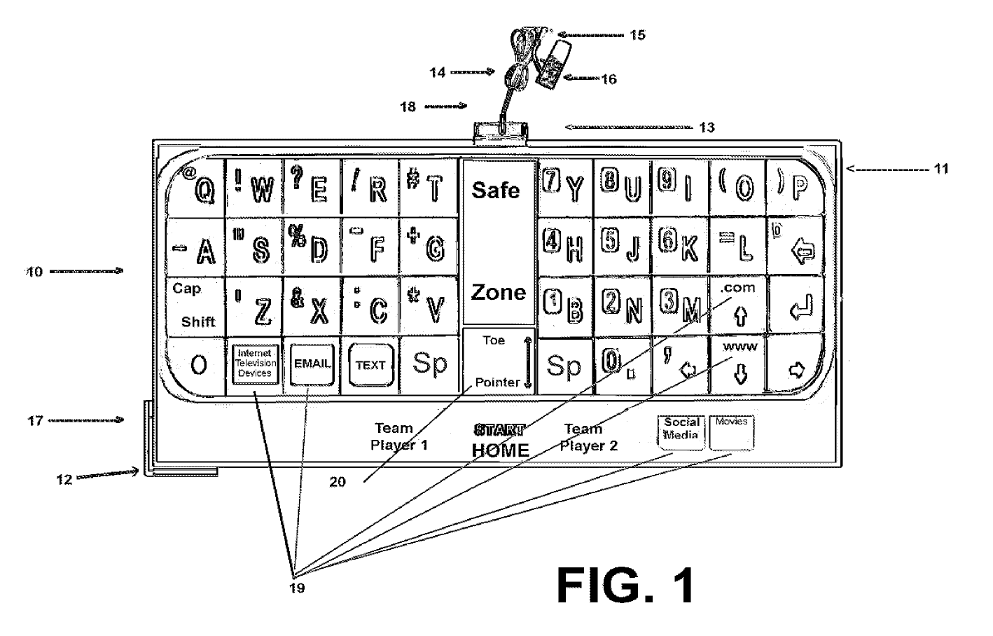

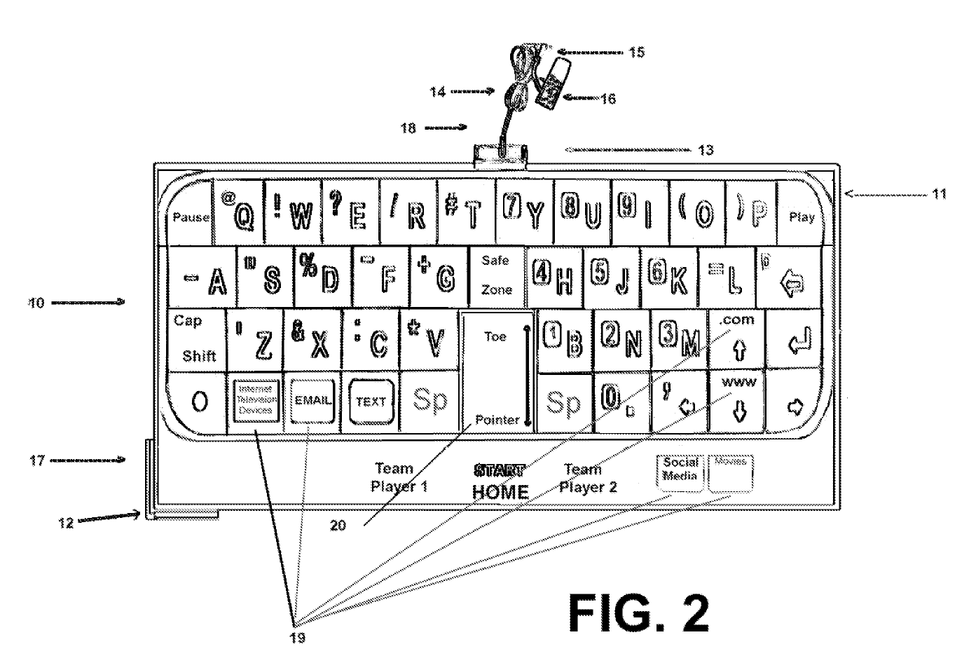

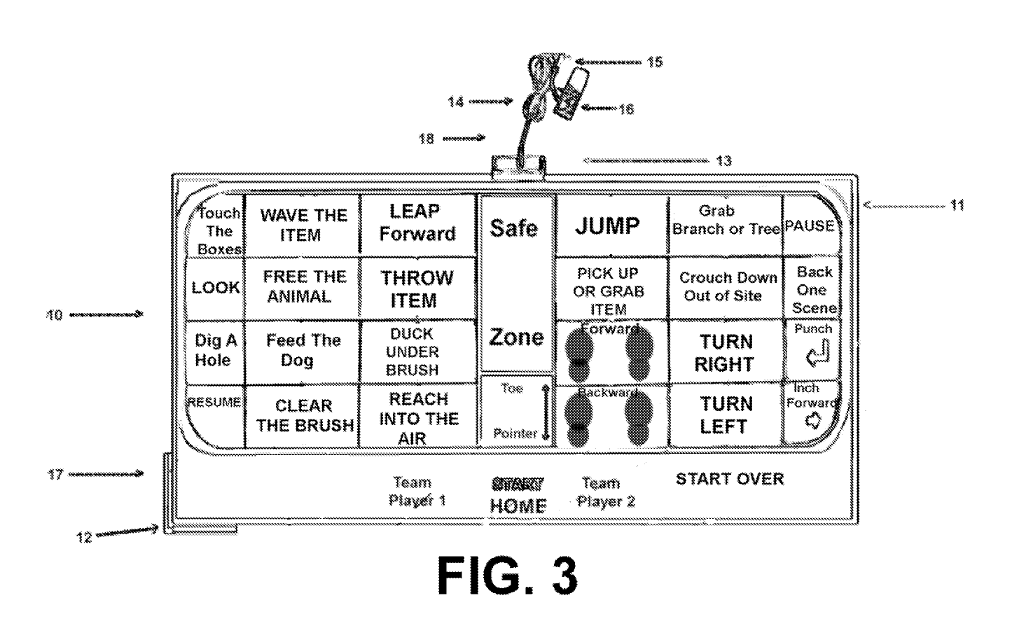

Referring now to FIGS. 1 through 3, a printed top 10 can be made from vinyl, plastic, rubber composite or the like and can contain the printed graphic of a proprietary key layout as shown in FIGS. 1 and 2 or a printed optional overlay graphic on a polymer or vinyl composite, for example, as shown in FIG. 3 which is intended to be affixed by, for example, a hook and loop fastener, such as Velcro™, or snaps or the like, over the first key layout. FIG. 3 is just one example, as any number of video game instructions may be printed onto this option depending upon the game produced. This layout may also be accomplished with symbols or 3D graphics, for example. The top can include a vinyl or a plastic composite or polymer not to exceed about 2 mm thickness. The original shipping version can utilize the type of top shown FIG. 1 or FIG. 2. Optional overlays and companion software would be made available later, as shown in FIG. 3.

A bottom surface 17 of the mat can be manufactured of rubber, thermoplastic elastomer or other copolymers. These materials, similar to yoga mat materials, can provide cushioned support to the foot when jumping onto the switches.

Conductive ink circuit layers 12 can be disposed between the printed top 10 and the bottom surface 17. These inner layers can be made, for example, of polymers but much thinner than the printed top 10 and the bottom surface 17 of the mat. The printable polymers can be the approximate thickness of cellophane, and are printed with carbon and conductive inks to create the path along which the signal will travel when the conductive ink is triggered by the pressure of a foot.

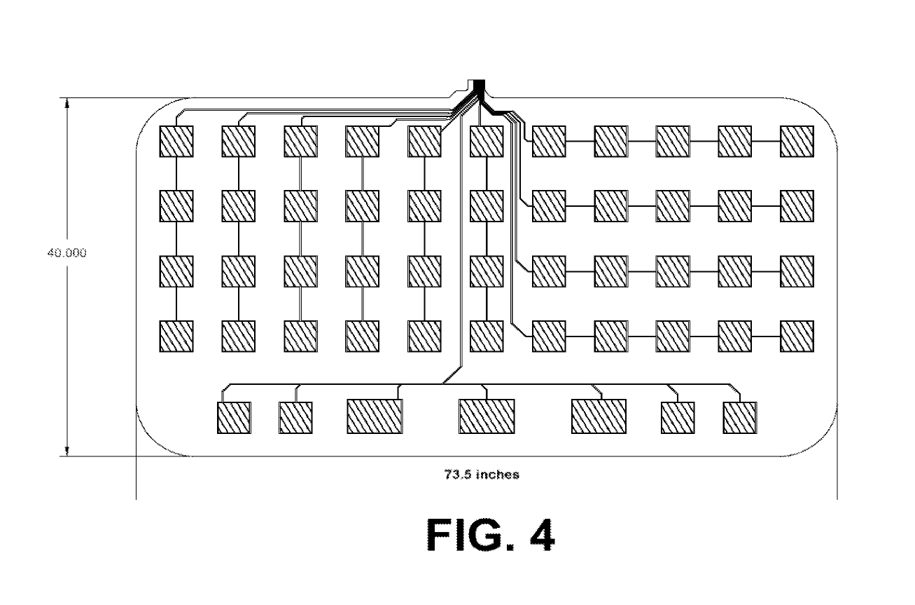

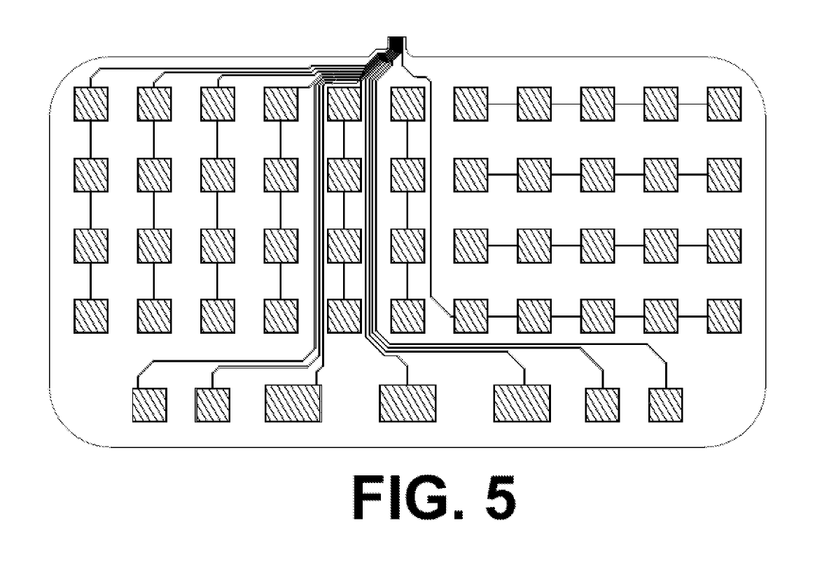

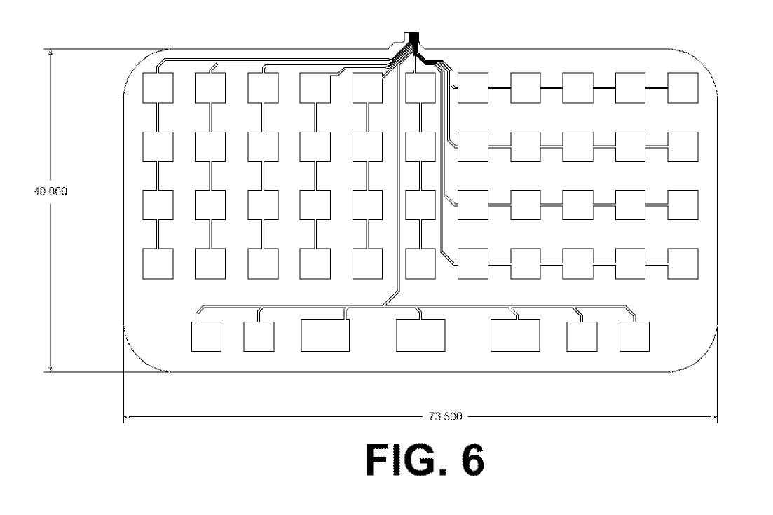

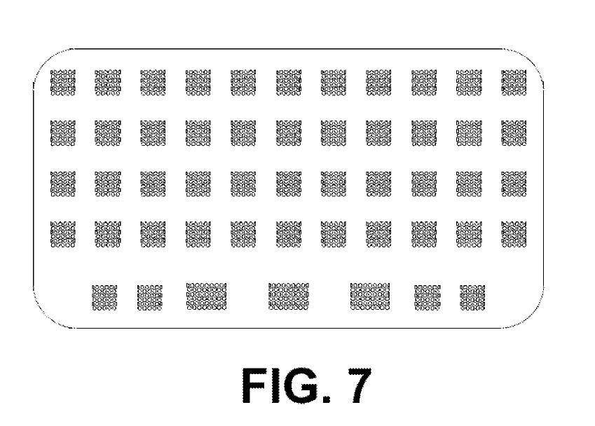

As shown in FIGS. 4 through 7, in one embodiment of the present invention, a top and a bottom conductive ink layer (FIGS. 4 and 5, respectively) can be disposed, facing each other with a foam layer (FIG. 7) disposed therebetween. The foam layer can be, for example, about 0.150 inch thick open cell foam and contains holes punched to allow the switches to close only in the areas which pressure of the foot should trigger a symbol or action. Two carbon layers (FIG. 6) can be disposed to sandwich the top and bottom conductive ink layers. Typically, the top and bottom conductive ink layers can be disposed to face each other, where diagonal silver lines intersect to create a waffle type of grid. More or fewer silver traces can be used, depending upon the targeted age and application.

The signal will travel to the controller head that sits at the top of the mat which then conveys the signals either via Wi-Fi or Bluetooth (or other similar wireless technology) to the processor contained within the companion device with which it is used, be it a TV, computer, gaming console or tablet device. In one configuration, a handheld controller 16 helps backspace, forward, cursor up, cursor down, erase, stop, start or select software. The handheld controller is in direct communication with the companion device and not with the mat. In a second possible configuration of the device, an advanced handheld controller will include switch sensing technology and a feedback loop that will tell the companion device (where companion device refers to the Internet enabled TV, computer, gaming device or tablet) which player is moving on which switches. In the advanced handheld generation, the handheld device WILL be in direct communication with the mat. That same circuit would sense if a player holding the handheld controller 16 had completed a circuit, thereby allowing the software to identify the player.

A central controller 13 can have a standard keyboard qwerty mapping and alternate mapping for more elaborate game play. The central controller 13 can connect to cables 14, providing connectivity to a variety of ports and devices. In some embodiments, a wireless adaptor card 18 allows wireless communication between the mat and the companion device, or, in a second generation, between the mat and the advanced handheld controller 16. If used in the wireless configuration, then the central controller 13 will not be attached by cables to the companion device but will instead include adapters for various types of wireless protocols. At least one USB, or other similar type cable 15 can be used to provide connectivity to a variety of ports and devices, including any proprietary connections that may be required if the device were licensed by existing gaming consoles.

The sum total of the layers is held together at the outer edges, bound via, for example, a stitched nylon edge 11. In some embodiments, this edge 11 can be a one-inch stitched nylon edge.

The standalone hand-held controller 16 enables the user to delete incorrect entries via a backspace or to start, stop or resume games, and, in an advanced configuration, to be identified by the circuitry of the mat via the completion of a very low voltage body circuit which signal is sent to the main controller to identify the player.

Internet and email buttons and switches 19 can include the circuitry required to add internet browsing, email, text and social media functionality. In some embodiments, a toe activated pointing device 20 can be incorporated to allow movement of the cursor around the screen.

The device of the present invention includes character mapping in the circuitry that allows the user to select alpha characters, numeric characters in a calculator style layout, or select symbols, browsing, social media or game zones, all with the use of the feet by jumping or hopping. The circuitry of the device allows the characters and symbols to appear on TV or monitor precisely as though one were selecting those items on a smaller device, and the toe pointer area, (when it is included) allows cursor movement via a slide of the toes similar to the action of fingers on a laptop pointing pad or on a touch-screen mobile device. The circuitry of the device also allows alternate programming of the switches to provide a screen response that will enable various video game play with the use of an optional thin printed graphic overlay showing the moves available for that particular game. It is expected that optional overlays would be affixed with Velcro™ or snaps.

The current dance mats available as gaming devices do not make any contribution to the education of a child beyond coordination nor do they speak to the communication needs of adults and children alike who use text or email. Currently, text email and browsing devices must be used while stationery with only one's fingers (i.e. smartphones). The other mats available or patented appear to provide only physical benefit with no component of social interaction. As the world becomes even more connected via the Internet, it is conceivable that many more hours of our lives would be spent on small devices in a stationery position and will further advance the inactivity that is contributing to obesity in our world. In addition, more and more of the hours in a day could be expected to spent on social interaction via social media, on long distance internet gaming, and on browsing the internet for both educational and entertainment purposes. The all-inclusive foot-activated floor mat device is capable of making a great contribution toward reversing that trend by taking its place as a primary peripheral for all computer uses.

Below are some of the significant differences between the present invention covered herein and others:

a) The device of the present invention is a flexible, reflective electronic floor mat with proprietary key layout, pointing device and play zones, for games, texts, browsing, internet TV and social media, including an option for overlays for more elaborate game play, with all switches selected by jumping, hopping, or walking.
b) The device of the present invention, in its initial version, contains only 4 rows of characters, whereas an existing QWERTY keyboard mat patent shows five rows in the style of a traditional typewriter. The layout of this device is closer to a style most teens are accustomed to on their smaller devices. Typically from about 40 to about 100 buttons can be provided on a single mat.
c) The device of the present invention is much larger than those currently envisioned in existing patents and with much larger keys. The adult version can be at least eight feet wide. The child version can be six feet wide and the serious gamer version will be 12 feet. Anything smaller than six feet would cause a young adult to continually step on two characters at once.
d) The modified keyboard mat of the present invention includes safety zones specifically designed for game play: a center SAFE zone or rest zone and a bottom START zone or HOME zone, as well as buttons for social media, web browsing, text, email and a pointing device, when included, where one uses one's foot to slide around a rectangle on the floor mat and the resulting action moves the cursor around the viewing screen.
e) The device of the present invention can be manufactured of reflective and fluorescent materials for media room play or night play.
f) The device of the present invention is too large to simply tap by foot—in fact, it is specifically designed so that children, teens and adults will be forced to “hop” around the mat using the safe zone if needed as a rest for one foot. This ramps up the physical benefits of use. There will be a companion “safe zone” in each optional overlay as well, intended as a resting place where stepping on that area will not trigger any circuit activity.
g) The bottom 6 to 10 inches in the HOME or START zone are intended to provide a place for players to start their speed games. Any mat that eliminates this feature would create a situation whereby players could trip over the edge of the mat with their toes.
h) The device of the present invention is available in a two mat system for team play and team races.
i) The device of the present invention is available in both wired and wireless versions, supporting USB, and various types of wireless protocols, such as Bluetooth.
j) The device of the present invention is compatible with at least one game console currently on the market.
k) The device of the present invention is accompanied by one or two wireless handheld remote/controller(s) for starting, stopping, selecting and resuming games, or for cursor movements (for example, via a trackball pointer) forward, backward, up or down, and for sensing, in some games that will use the advanced handheld controller, the identity of a particular player via a loopback technology incorporating very low voltage body current. Game results appear on TV or monitor.

When a person jumps on, or steps on the mat at the desired character or symbol, the chosen character appears on screen.
i. The user may backspace, create symbols, spaces, caps, numbers etc. similar to the process of selecting those on a smaller device, but with feet, not fingers.
ii. In order to create symbols, one jumps onto the green “Function” button at the lower left of the mat, and the choices will then generate the symbols that appear in the upper left hand position of that box. Another hop onto the “Function” button returns the selections to the main characters in the center of each box. The use of a “Function” button allows an array of alpha, numeric and symbol characters in the smallest possible space, enabling each character to be at maximum size within the planned 6 to eight foot manufacture width of this device and enabling then a more physical experience to navigate from one button to the next
iii. Jumping onto the “Function” button and then www generates a browser with http:// in the screen ready to accept a url or a search term. Entering a search term will initiate a search engine as occurs within any browser.
iv. Hopping onto the internet television button will allow access to one's favorite movies or music sites normally available on currently marketed Internet television devices.
v. Hopping onto the email or text buttons will call up applications that will enable texting and email. Hopping onto the blank lower right buttons will initiate a sequence that will allow the user to “set” each button to a favorite social media or movie site.
vi. Standing in the “safe” zone and extending one foot into a specifically marked area on the mat, when included, and sliding one's foot around that area results in movement of the cursor around the monitor for all applications where a user would normally use a touch-screen and in all functions where one would normally use the pointing pad on a laptop.
vii. In the option where user affixes a plastic, vinyl or polymer composite layer printed with a new graphic onto the original mat, FIG. 3, stepping, jumping and hopping will trigger the same switches, no wiring change is necessary, but software reprograms the response of the triggered circuit such that a character on screen performs an action instead of a letter or symbol.

There are various applications for the device of the present invention. These applications including using the device a) for educational and fitness-oriented spelling games; b) for standard communication, browsing, texting and social media; and c) for serious gamers with the use of a printed vinyl or polymer overlay to be shipped with specific software.

When one's bored child wants to stop homework and text a friend or check a social site, the authority figure might give that child permission only if that child will use the new keyboard mat. There is no limit to how much physical activity a child or adult could achieve by communicating on the foot-driven floor mat versus a traditional keyboard. Even an hour a day will make a huge difference in fitness levels. The apparatus will encourage many games and competitions across the internet as well as on various operating systems or in the classroom and will be a welcome diversion for the busy executive. Simply text using your internet television or regular flat screen TV with an attached internet television box and add the mat in place of the keyboard that normally accompanies these (an internet television includes the technology to accept input from a wired or wireless keyboard device). The compatibility of this device with gaming systems as well as computers will make many more developer applications possible that will incorporate active involvement and calorie burning on the part of the user.

The logic required for the invention is a layout of a circuit board on thin flexible plastic membrane surfaces and conductive inks to correspond to the desired character mapping in the controller head. The processor, whether a desktop, laptop, game console, tablet or internet television device, incorporates the technology for interpreting the switches as characters and buttons. Quite simply, if person steps on circuit line A, then voltage is generated to the character map circuitry such that the letter A appears on screen. In the case of a printed overlay for more elaborate gaming use, the programming of the A is software driven and may create any number of actions of a character in a video game instead of producing an “A” on the screen.

To make the invention, a proprietary graphic with alpha characters, symbols, a pointing pad, game zones, internet switches or “buttons” and social media buttons is printed onto a top surface of vinyl, plastic or other water resistant but flexible composite material and mass-produced to consist of the top layer. This layer can be printed in reflective inks on a reflective surface such that the characters will all have a glow in the dark appearance. Characters and symbols may include a more heavily textured surface, or, optionally, a molded underside, for tactile response without looking down during the game. In addition, a sealing laminate with a textured surface will be applied for a nonskid finish.

The bottom surface, the surface that will touch the floor, can be a material similar to a rubber or thermoplastic elastomer, similar to the fabric of which thin Yoga mats are made. This will provide a somewhat cushioned hopping experience, yet will still be thin. Typically, the bottom surface can be made from either a rubber composite, a thermoplastic elastomer material, or a copolymer compound with a nonskid bottom surface for use on a smooth hardwood or ceramic floor.

The three inner layers, including the printed circuit board can be engineered of very thin, flexible, clear plastic films meant to accept conductive inks for the printed circuit lines leading from the controller head or board to each character. This will contain an extra insulating layer of very thin foam to achieve resistance and the proper opening and closing of the circuit; this is called the “separator” layer. Only a very modest center circular area of each character will contain the circuit and thus be responsive to the foot helping to assure that the user does not activate more than one character at a time. For the child version, each character box is currently planned at 7¼ inches by 5¾ inches but the active portion of the circuit switch lies in a 3″ by 3″ center area of the box. Other sizes for both the character box and the active portion of the circuit switch are contemplated within the scope of the present invention.

The circuit controller and network adapters will be contained in a controller head attached to the top of the mat. Once the electronics are in place, the entire set of layers will be stitched with a heavy silver nylon edging. The mat will be able to be rolled into a tube shape for transport, sale and storage and will be sold with a mesh or net carrying case with a molded foam insert at its bottom for securing the attached controller head of the circuit board, see diagram. The mat is portable and water resistant (though not specifically waterproof) and can be wiped down with soap and water and left to air dry. The mat's portability and easy to clean characteristics are essential to the appeal of the device.

In some embodiments, the character squares to produce sound or lights for games barring any technical difficulties that would add too greatly to its weight or rollability. In addition, the use of optional overlays FIG. 3 will allow the reprogramming of letters to actions in a video game.

To use the device of the present invention, a child or adult simply triggers the switches with his or her feet, by hopping and jumping. In the first planned software, speed spelling games will be played with the users typing with their feet by hopping onto the mat. In the initial version, the user may also use their feet to speed text or speed email for an invigorating physical experience. Communicating via feet would be exactly the same as communicating via fingers only with a higher level of exertion. The activity, the fun, the interaction, the competitions and the novelty of this device will greatly aid in the fight against child obesity, and adult obesity due to sedentary lifestyle and long hours in front of a keyboard.

Users can type away with their feet and burn calories while visiting online with family members on a social media site, or select a movie online with their feet before settling in to watch. Users can text and email friends to keep in touch while keeping fit.

Users may browse the internet with feet or visit social media sites and update statuses. Standing in the “safe” zone and extending one foot into a specifically marked area on the mat and sliding one's foot around that area results in movement of the cursor around the monitor for all applications where a user would normally use a touch-screen and in all functions where one would normally use the pointing pad on a laptop.

Two mats may be used simultaneously for competition games where teams race each other to spell words by jumping or hopping onto the characters, or where teams race each other to spell words “twister” style (hands and feet must remain on the mat), but many games and functions are made for only one user and one mat.

Two mats may be used side by side for more elaborate gaming where the two mats complete a 12 by 12 grid and overlaid graphics identify new moves that would be enabled by software. In the case of overlays and specific software that would change the response of a specific key. For instance, an overlay of a Treasure Hunt through the woods would have companion software that could program the B and N keys in such a way that stepping on them alternately would cause the screen character to walk through the woods, and the Y key could be used for jumping over a stream, forcing the player to literally jump onto the Y. The printed graphic overlay in this option would be affixed by Velcro to the initial mat. The areas over B and N could show a pair of footprints and the area over the Y would simply say “JUMP.” This option could be enabled with only one mat, or optionally, with two mats creating a full 12 foot by 12 foot physical experience for the players.

The original device, a single mat without an optional overlay, may be used regularly as the primary peripheral for aerobic texting, browsing, social media and gaming for children and aerobic business communication for adults.

If any one or two particular above features are deemed to be not cost effective or not portable as of currently-known manufacturing processes, it is intended that such condition(s) will not flaw the patent and the device will be manufactured without said feature(s) until the named technology can be made small enough and light enough to comply with out intended portability of this device.

It should be understood, of course, that the foregoing relates to exemplary embodiments of the invention and that modifications may be made without departing from the spirit and scope of the invention as set forth in the following claims.

What is claimed is:

1. A flexible floor mat comprising:
a keyboard graphic top panel defining a plurality of keys;
a plurality of switches disposed under the plurality of keys, wherein pressure applied to one of the plurality of keys closes one of the plurality of switches; and
a bottom side resistant to slipping on a floor surface, wherein
at least one of the plurality of keys is dedicated to social media interaction;
at least one of the plurality of keys is dedicated to an internet browser; and
at least one of the plurality of keys is dedicated to a texting application.

2. The flexible floor mat of claim 1, wherein the keyboard graphic top includes reflective or fluorescent characters, numbers or symbols.

3. The flexible floor mat of claim 1, wherein the plurality of switches create at least one of a sound and a light when activated.

4. The flexible floor mat of claim 1, further comprising a hand-held controller interactive with the flexible floor mat.

5. The flexible floor mat of claim 4, wherein the hand-held controller is a wireless controller having a trackball pointer.

6. The flexible floor mat of claim 1, wherein the plurality of keys are spaced apart so that a user hops or jumps between keys.

7. The flexible floor mat of claim 1, wherein at least one of the plurality of keys is a safe zone where stepping on the safe zone does not trigger one of the plurality of switches.

8. The flexible floor mat of claim 1, further comprising at least one swappable graphic overlap disposable over the keyboard graphic top to provide an alternate configuration for the plurality of keys.

9. The flexible floor mat of claim 1, wherein a subset of the plurality of keys mimics a 10-key calculator.

10. The flexible floor mat of claim 1, further comprising a wireless device operable to allow the flexible floor mat to communicate with other devices.

11. A flexible floor mat comprising:
a keyboard graphic top panel defining a plurality of keys;
a plurality of switches disposed under the plurality of keys, wherein pressure applied to one of the plurality of keys closes one of the plurality of switches;
a bottom side resistant to slipping on a floor surface; and
a hand-held controller having a trackball that is interactive with the flexible floor mat, wherein
at least one of the plurality of keys is dedicated to social media interaction;
at least one of the plurality of keys is dedicated to an internet browser;
at least one of the plurality of keys is dedicated to a texting application;
a subset of the plurality of keys mimics a 10-key calculator; and
at least one of the plurality of keys is a safe zone where stepping on the safe zone does not trigger one of the plurality of switches.

12. The flexible floor mat of claim 11, wherein the keyboard graphic top includes reflective or fluorescent characters, numbers or symbols.

13. The flexible floor mat of claim 11, wherein the plurality of switches create at least one of a sound and a light when activated.

14. The flexible floor mat of claim 11, further comprising at least one swappable graphic overlap disposable over the keyboard graphic top to provide an alternate configuration for the plurality of keys.
